(19) United States
(12) Patent Application Publication
(10) Pub. No.: US 2025/0028278 A1
(43) Pub. Date: Jan. 23, 2025

(54) SYSTEM AND METHOD FOR CONTROLLING A METASURFACE

(71) Applicant: HUAWEI TECHNOLOGIES CO., LTD., Shenzhen (CN)

(72) Inventor: Huanhuan GU, Nepean (CA)

(21) Appl. No.: 18/904,666

(22) Filed: Oct. 2, 2024

Related U.S. Application Data
(63) Continuation of application No. PCT/CN2022/084943, filed on Apr. 2, 2022.

(51) Int. Cl. G03H 1/04; H01Q 15/00

(52) U.S. Cl. CPC G03H 1/0443; H01Q 15/0086; G03H 2001/0452

(57) ABSTRACT

A system is used to control a metasurface having formed thereon subwavelength structures each encoded with holographic information. The system includes one or more transmitters and a controller. The control is configured to control the one or more transmitters to generate one or more radiation patterns. Each radiation pattern includes one or more radio-frequency (RF) beams directed towards the metasurface for interacting with one or more of the subwavelength structures to thereby output, from the metasurface, electromagnetic waves for reconstructing at least some of the holographic information.

### CROSS-REFERENCE TO RELATED APPLICATION

This application is a continuation of Patent Cooperation Treaty Application Serial No. PCT/CN2022/084943, filed Apr. 2, 2022, the content of which is incorporated herein by reference in its entirety.

### TECHNICAL FIELD

The present disclosure relates to wireless technology, and in particular relates to systems and methods for controlling a metasurface.

### BACKGROUND

A computer-generated hologram can be used to encode graphic information. When an appropriate electromagnetic (EM) wave is incident on the hologram, the graphic information encoded in the hologram can be reconstructed. Recent developments in nanotechnology have made it possible to encode graphic information in a metasurface which is a surface having subwavelength artificial structures (i.e. artificial structures that are substantially smaller than the wavelength of an incident EM wave). When an EM wave is incident on the metasurface, these structures perform wavefront manipulation on the incident EM wave, and can manipulate parameters (e.g. the amplitude, phase, and polarization) of the incident EM wave. The outgoing EM wave may enable the graphic information encoded in the metasurface to be reconstructed.

### SUMMARY

According to a first aspect of the disclosure, there is provided a system for controlling a metasurface having formed thereon subwavelength structures each encoded with holographic information, the system comprising: one or more transmitters; and a controller configured to: control the one or more transmitters to generate one or more radiation patterns, each radiation pattern comprising one or more radio-frequency (RF) beams directed towards the metasurface for interacting with one or more of the subwavelength structures to thereby output, from the metasurface, electromagnetic waves for reconstructing at least some of the holographic information.

Accordingly, existing transmitters (such as RF antennae provided in consumer devices, such as mobile devices) may be used to control or excite a metasurface so to output, from the metasurface, electromagnetic waves for reconstructing holographic information. This may increase the utility of such devices.

Each transmitter may comprise an antenna array or a reconfigurable intelligent surface. Thus, an antenna array may be used to generate the radiation pattern, or a reconfigurable intelligent surface may be controlled (for example, by changing the electric and magnetic properties of the reconfigurable intelligent surface) so as to generate the radiation pattern. Therefore, a relatively large variety of different transmitters may be used to generate the radiation pattern comprising the one or more RF beams.

The system may be a user device, such as a mobile device, and may not comprise the metasurface. For example, the user device may comprise the transmitter and may control the transmitter to control or excite the metasurface that is external to the user device.

Alternatively, the system may comprise the metasurface. For example, the system may be a display unit comprising the metasurface.

The metasurface may comprise: an array of surface tiles, each surface tile having formed thereon one or more of the subwavelength structures. Therefore, different subwavelength structures may be provided on the metasurface. For example, different tiles may have formed thereon different subwavelength structures, and as a result the metasurface may be used for larger-bandwidth applications.

The system may further comprise a first component configured to receive electromagnetic waves output from the metasurface when the one or more RF beams interact with the one or more of the subwavelength structures; and a second component configured to reconstruct the at least some of the holographic information based on the received electromagnetic waves.

The system may be a user device comprising the first component and the second component.

Therefore, the holographic information may be reconstructed by using a device that may, for example, be external to the metasurface. Alternatively, the holographic information may be reconstructed by using a device that may comprise the metasurface.

A size of an aperture of the one or more transmitters may be not greater than \sqrt{Sλ/2}, wherein S is a distance between the one or more transmitters and the metasurface, and lambda is a wavelength of the electromagnetic waves.

The subwavelength structures may comprise: a first subwavelength structure formed on a first surface tile of the metasurface and encoded with first holographic information; and a second subwavelength structure formed on a second surface tile of the metasurface and encoded with second holographic information. The controller may be further configured to: control the one or more transmitters to direct the one or more RF beams towards the first and second surface tiles of the metasurface. Therefore, different tiles of the metasurface may be configured to output different holographic information.

The controller may be further configured to: control the one or more transmitters to direct the one or more RF beams towards the first surface tile of the metasurface; and subsequently, control the one or more transmitters to direct the one or more RF beams towards the second surface tile of the metasurface.

The controller may be further configured to control the one or more transmitters to simultaneously direct the one or more RF beams towards the first and second surface tiles of the metasurface.

Therefore, different holographic information may be output from the metasurface either sequentially or in parallel, depending on how the one or more RF beams are directed towards different surface tiles of the metasurface.

According to a further aspect of the disclosure, there is provided a method of controlling a metasurface having formed thereon subwavelength structures encoded with holographic information, the method comprising: controlling one or more transmitters so as to generate one or more radiation patterns each comprising one or more radio-frequency (RF) beams that are directed towards the metasurface, wherein the one or more RF beams interact with one or more of the subwavelength structures so as to output, from the metasurface, electromagnetic waves for reconstructing at least some of the holographic information.

The method may further comprise: receiving the electromagnetic waves output from the metasurface; and reconstructing the at least some of the holographic information based on the received electromagnetic waves.

The one or more subwavelength structures may comprise: a first subwavelength structure formed on a first surface tile of the metasurface and encoded with first holographic information; and a second subwavelength structure formed on a second surface tile of the metasurface and encoded with second holographic information. Controlling the one or more transmitters may comprise controlling the one or more transmitters so as to direct the one or more RF beams towards the first and second surface tiles of the metasurface.

Controlling the one or more transmitters may comprise: controlling the one or more transmitters so as to direct the one or more RF beams towards the first surface tile of the metasurface; and subsequently, controlling the one or more transmitters so as to direct the one or more RF beams towards the second surface tile of the metasurface.

Controlling the one or more transmitters may comprise controlling the one or more transmitters so as to direct the one or more RF beams simultaneously towards the first and second surface tiles of the metasurface.

The one or more RF beams may comprise a first RF beam and a second RF beam. Controlling the one or more transmitters may comprise: controlling the one or more transmitters so as to direct the first RF beam towards a first surface tile of the metasurface, the first surface tile having formed thereon a first subwavelength structure of the one or more subwavelength structures and encoded with first holographic information, wherein the first RF beam interacts with the first subwavelength structure so as to generate first electromagnetic waves; and controlling the one or more transmitters so as to direct the second RF beam towards a second surface tile of the metasurface, the second surface tile having formed thereon a second subwavelength structure of the one or more subwavelength structures and encoded with second holographic information, wherein the second RF beam interacts with the second subwavelength structure so as to generate second electromagnetic waves.

The method may further comprise, prior to controlling the one or more transmitters: receiving one or more signals having encoded therein information based on the holographic information. For example, the one or more signals may include encoded holographic information, or may contain information that can be used to identify holographic information. Controlling the one or more transmitters may comprise controlling the one or more transmitters so as to generate one or more radiation patterns based on the information encoded in the one or more signals.

Receiving the one or more signals may comprise receiving the one or more signals at a user device. Controlling the one or more transmitters may comprise controlling the one or more transmitters using the user device. The method may further comprise: receiving, at the user device, the electromagnetic waves output from the metasurface; and reconstructing the at least some of the holographic information based on the received electromagnetic waves.

The one or more transmitters may be spaced apart from the metasurface by a distance of at least 2D²/λ, wherein D is a size an aperture of the one or more transmitters, and lambda is a wavelength of the electromagnetic waves.

This summary does not necessarily describe the entire scope of all aspects. Other aspects, features and advantages will be apparent to those of ordinary skill in the art upon review of the following description of specific embodiments.

### BRIEF DESCRIPTION OF THE DRAWINGS

Embodiments of the disclosure will now be described in detail in conjunction with the accompanying drawings of which:

FIG. 1 shows a system for controlling a metasurface, according to an embodiment of the disclosure;

FIG. 2 shows an antenna array generating a radiation pattern comprising a radio-frequency beam, according to an embodiment of the disclosure;

FIG. 3 shows a two-dimensional plot of a radiation pattern, according to an embodiment of the disclosure;

FIGS. 4A-4E show example three-dimensional radiation patterns generated using an antenna array, according to embodiments of the disclosure;

FIG. 5 shows an antenna array and a metasurface in a display unit, and user devices reconstructing holographic information output from the metasurface, according to an embodiment of the disclosure; and

FIG. 6 shows antenna arrays, in user devices, controlling a metasurface, and the user devices reconstructing holographic information output from the metasurface, according to an embodiment of the disclosure.

### DETAILED DESCRIPTION

The present disclosure seeks to provide improved systems and methods for controlling a metasurface. While various embodiments of the disclosure are described below, the disclosure is not limited to these embodiments, and variations of these embodiments may well fall within the scope of the disclosure which is to be limited only by the appended claims.

Generally, according to embodiments of the disclosure, there is provided a system for “exciting” or otherwise controlling a metasurface having formed thereon subwavelength structures. Each subwavelength structure is encoded with holographic information. One or more transmitters, such as antenna arrays or reconfigurable intelligent surfaces (RIS), are used to generate one or more radiation patterns that interact with the metasurface. If an antenna array is being used, a controller (such as analog circuitry or a microprocessor) is used to control the antenna array to generate a radiation pattern comprising one or more radio-frequency (RF) beams. A reconfigurable intelligent surface may be used in addition, or alternatively, to an antenna array. Whereas an antenna array actively generates a radiation pattern under control of the controller, an RIS is a two-dimensional surface of engineered material whose properties are reconfigurable rather than static. An RIS can be used to control the propagation of electromagnetic waves by changing the electric and magnetic properties of the surface of the RIS.

According to the present disclosure, while it shall be understood that both an antenna array and an RIS may be used for controlling a metasurface, for the sake of clarity, embodiments in the following description shall be described in the context of an antenna array being used to control a metasurface. It shall be understood, however, that an RIS may equally well be used for controlling the metasurface.

The RF beams of the radiation pattern are directed towards the metasurface and interact with one or more of the subwavelength structures. Because of the particular design of the subwavelength structures, the subwavelength structures interact with the incident EM waves of the RF beams to thereby output, from the metasurface, EM waves that contain the holographic information encoded in the metasurface. These EM waves may be received at a suitable device capable of reconstructing holographic information and the holographic information encoded therein may be reconstructed from the EM waves.

According to some embodiments, the antenna arrays and the metasurface may be comprised in a display unit, such as a television or the like. The antenna arrays may be controlled so as to excite or otherwise control the metasurface and, as described above, cause the metasurface to output the electromagnetic waves with the holographic information encoded therein. The EM waves may then be received at one or more user devices, such as one or more mobile devices. The mobile devices may reconstruct the holographic information encoded within the EM waves, using any of various techniques known in the art.

According to some embodiments, the antenna array may be comprised in a user device (or multiple antenna arrays may be comprised in multiple user devices), and the metasurface may be external to the user device. In this case, a base station or similar transmitter may transmit one or more signals to the user device. The one or more signals contain information required for controlling the metasurface to output EM waves for the reconstruction of holographic information corresponding to the use device. The one or more signals may include encoded holographic information corresponding to the user device, or may contain information that can be used to identify holographic information corresponding to the user device. The one or more signals may include information indicating a radiation pattern (or related parameters that may define one or more beams of a radiation pattern) that may be used to cause the metasurface to output (or otherwise generate) EM waves for reconstruction of holographic information corresponding to the user device. The one or more signals may also include information identifying parameters that define a radiation pattern, such as side lobe level, peak, null, and direction.

The signals are received at the user device and are then used by the user device to control the antenna array in the user device so as to generate a radiation pattern, which may be determined based on the one or more signals, and that may excite the metasurface to output (or otherwise generate) EM waves for reconstruction of holographic information corresponding to the user device. If the one or more signals include information identifying holographic information corresponding to the user device, the user device may determine a radiation pattern corresponding to the holographic information and control the antenna array in the user device so as to generate the determined radiation pattern. In particular, the one or more RF beams of the radiation pattern are directed towards the metasurface and, as described above, cause the metasurface to output electromagnetic waves with the holographic information encoded therein. The EM waves output from the metasurface may then be received at the user device. The user device may then extract (or reconstruct) the holographic information encoded within the EM waves, using any of various techniques known in the art.

The metasurface may comprise multiple surface portions or “tiles”. Each tile may have formed thereon one or more of the subwavelength structures. By controlling the antenna array to as to direct or steer the RF beam or beams towards specific tiles, certain tiles of the metasurface may be switched “ON” while other may be kept “OFF”. The switching ON of a tile means that the EM waves of the RF beam interact with one or more of the subwavelength structures of the tile, so as to cause the tile to output EM waves that are based on an interference between the incident EM waves and the one or more subwavelength structures of the tile. The switching OFF of a tile means that the EM waves of the RF beam do not interact with one or more of the subwavelength structures of the tile.

According to some embodiments, a single tile may be configured to interact with multiple different RF beams. For example, a single tile may contain a first subwavelength structure configured to interact with a first parameter of an EM wave (for example, an EM wave of a first frequency), and the same tile may contain a second subwavelength structure configured to interact with a second parameter of an EM wave (for example, an EM wave of a second frequency).

Therefore, the metasurface may be excited or controlled by incident EM waves comprised in one or more RF beams. As a result of the interaction of the EM waves in the RF beams with the subwavelength structures of the metasurface, EM waves may be output from the metasurface. These EM waves contain the holographic information encoded within the subwavelength structures of the metasurface. Generally, the RF beams may be multiplexed to include, for example, multiple bandwidths or frequencies. This may enable a single RF beam to cause a single tile of the metasurface to output different EM waves, thereby increasing the degree of information that may be output from the metasurface. Increasing the degree of information means that each tile may represent multiple different information units (and not only 0 or 1), such as a symbol, a shape, or an image.

Multiple beams generated by an antenna array may enable the flexible switching ON and OFF of certain tiles or combinations of titles of the metasurface. The tiles that are switched ON by the multiple beams generated by the antenna array may result in the metasurface outputting EM waves for the display of a full image or video.

Algorithm-based optimization techniques, or other similar techniques, may be used to generate radiation patterns with the desired RF beams in order to controllably excite select portions (or tiles) of the metasurface.

According to some embodiments, one or more tiles of the metasurface may comprise a tunable material for increasing a bandwidth of the metasurface. For example, the tunable material may comprise a phase-changing material that presents different material properties depending, for example, on variations in temperature.

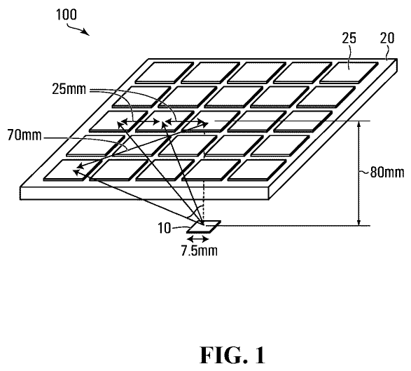

Turning to FIG. 1, there is shown an example embodiment of a system 100 for controlling a metasurface 20. Metasurface comprises a 5×5 array of tiles 25 arranged in a grid pattern. System 100 further includes a steerable antenna array 10 positioned a distance D from metasurface 20. Antenna array 10 comprises a 10×10 array of antenna elements (e.g. a steerable antenna array with 10 antenna elements along the x-axis and 10 antenna elements along the y-axis). In the particular embodiment of FIG. 1, each tile 25 has a size 25×25 mm and comprises a 50×50 array of subwavelength artificial structures (not shown). As described above, the subwavelength artificial structures may manipulate or otherwise change the wavefront of an incident EM wave. Antenna array 10 that is located 80 mm from metasurface 25. Under control of a controller (which may be, for example, a software module in combination with a hardware interface), antenna array 10 is configured to operate at 200 GHz (i.e. generate RF beams at 200 GHz), and has a dimension of 7.5×7.5 mm. Accordingly, the maximum beam steering angle of antenna array 10 is elevation θ=41 degrees and azimuth ϕ=45 degrees in spherical polar coordinates. Antenna array 10 may be spaced apart from metasurface 20 by a distance of at least 2D²/λ, (i.e. antenna array 10 should be in the far-field region), wherein D is a size an aperture of the antenna elements of antenna array 10, and lambda is a wavelength of the electromagnetic waves in the RF beams generated by antenna array 10.

The number of tiles 25 in metasurface 20, and the number of subwavelength artificial structures in each tile 25 of metasurface 20, may be varied based on the requirements of image resolution and information diversity. In particular, a relatively large metasurface 20 may require more than a single antenna array in order for all of the tiles of the metasurface to be dynamically switched ON or OFF. Simultaneous switching ON and OFF of tiles of the metasurface may be performed in order to output EM waves for the reconstruction and display of multiple images encoded into holographic information, or the three-dimensional display of images encoded into holographic information. In such a case, multiple antenna arrays may be controlled, or a multibeam antenna array (i.e. an antenna array operable to emit multiple, different RF beams) may be used, to dynamically switch ON and OFF tiles of the metasurface.

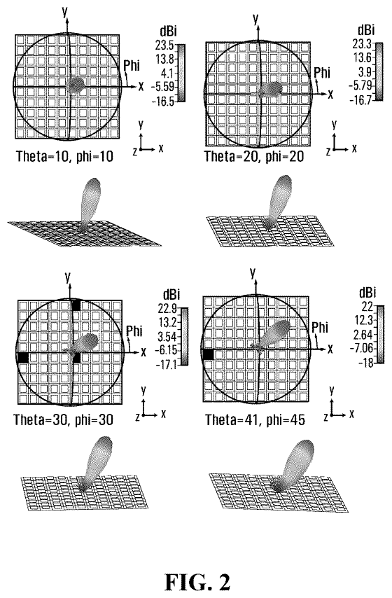

A simulation of a radiation pattern (comprising one or more RF beams) generated by an antenna array is shown in FIG. 2. As can be seen in FIG. 2, an RF beam is generated by an antenna array and may be steered to different θ (theta) and ϕ(phi) angles. Chebyshev excitation amplitude may be used to minimize the side lobe level (SLL) of the generated beam.

Greater flexibility over the control of the antenna array may be achieved by using any of various optimization algorithms, such as genetic algorithms (GA). The antenna array elements can be controlled to synthesize multibeams with proper side lobe level and beamwidth. Other parameters of the beam that may be controlled include peak, null, and direction.

The antenna array may be implemented in Field-Programmable Gate Arrays (FPGAs) or an Application-Specific Integrated Circuit (ASIC), and the radiation pattern generated by the antenna array may be synthesized or shaped in real-time.

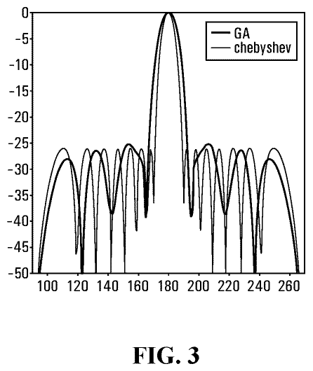

FIG. 3 shows a two-dimensional plot of a radiation pattern generated according to a genetic algorithm (GA) and according to a Chebyshev polynomial. As can be seen, the side love level of the radiation pattern generated according to the genetic algorithm is controlled to within −25 dB.

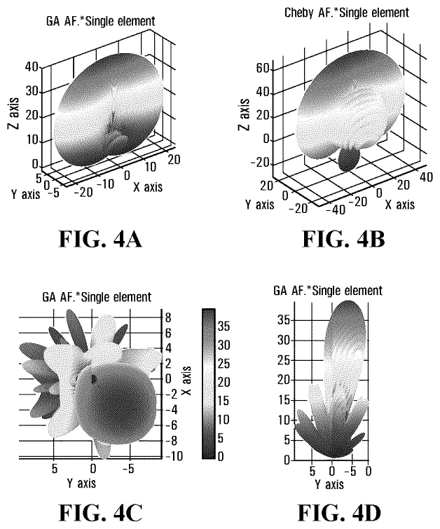

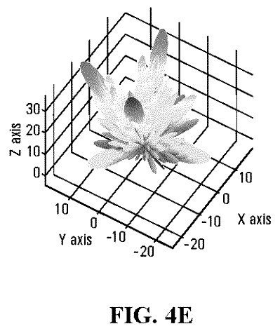

FIG. 4A shows a three-dimensional radiation pattern generated according to a genetic algorithm, and FIG. 4B shows a three-dimensional radiation pattern generated according to a standard Chebyshev polynomial.

FIGS. 4C and 4D show examples of a radiation pattern with steered beams.

FIG. 4E shows a radiation pattern with three peak lobes (e.g. three separate RF beams) pointed in three separate directions.

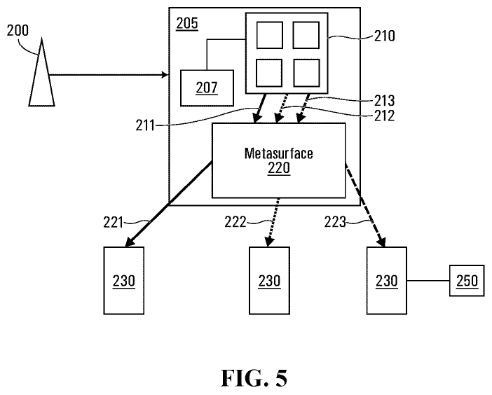

Turning to FIG. 5, there is shown an example use case of a system 205 for controlling a metasurface 220. As can be seen in FIG. 5, the system 205 is a display unit, such as a television, comprising both a controllable antenna array 210 and metasurface 220. A base station 200 encodes one or more messages into holograms, as described above. The one or more messages are transmitted to display unit 205. After receiving the one or more messages, a controller 207 of display unit 205 uses the one or more messages to generate a radiation pattern, by controlling antenna array 210. The one or more RF beams of the radiation pattern are directed towards metasurface 220. EM waves are output from metasurface 220, based on the interaction between the EM waves of the beams incident on metasurface 220 and the subwavelength structures of metasurface 220.

The EM waves output from metasurface 220 are received at one or more various user devices 230. Each user device 230 may then process the EM waves, using for example an on-board processor, or an FPGA 250 external to the user device. By processing the received EM waves, user devices 230 are able to reconstruct the holographic information encoded in metasurface 220. Such information may be displayed, for example, on displays of user devices 230.

As can be seen in the example case of FIG. 5, antenna array 210 is controlled so as to generate a radiation pattern with different RF beams 211, 212, 213. Each beam is configured, based on one or more properties of the its inherent EM waves, to interact with a select number of tiles or subwavelength structures of metasurface 220. As a result, different sets of EM waves 221, 222, 223 are output from metasurface 220, depending on which tiles or subwavelength structures are switched ON by beams 211, 212, 213. Accordingly, each user device 230 may reconstruct different holographic information, depending on the EM waves 221, 222, 223 that are received at the user device. This may be useful in the hypothetical example of, for example, a first user wishing to observe on their phone a first channel of their television, and a second user wishing to observe on their phone a second channel of their television.

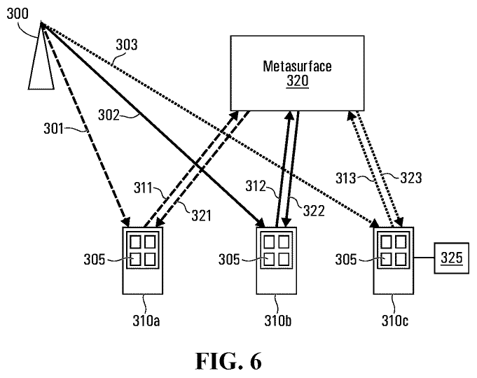

Turning to FIG. 6, there is shown another example use case of a system for controlling a metasurface 320. In this embodiment, instead of the metasurface and antenna arrays being integrated in a common module, the antenna arrays 305 are distributed across a number of user device 310, and metasurface 320 is external to user devices 310. As can be seen in FIG. 6, a base station 300 encodes one or more messages into holograms. The one or more messages are transmitted to user devices 310. Each user device 310 receives a different set 301, 302, 303 of encoded messages, so that each user device 310 may ultimately reconstruct different holographic information, as described in further detail below.

Each user device 310, in response to receiving the one or more messages from base station 300, uses the one or more messages to control the antenna array of the user device. In particular, the one or more messages are used to generate radiation patterns, corresponding to different users, using antenna array 305. The one or more RF beams 311 of a first radiation pattern correspond to user device 301a, the one or more RF beams 312 of a second radiation pattern correspond to user device 301b, and the one or more RF beams 313 of a third radiation pattern correspond to user device 301c. The RF beams 311, 312, 313 are respectively directed towards metasurface 320. EM waves 321, 322, 323 are output from metasurface 320, based on the respective interaction between the EM waves of RF beams 311, 312, 313 incident on metasurface 320 and the subwavelength structures of metasurface 320.

EM waves 321, 322, 323 output from metasurface 320 are received at respective user devices 310. Each user device (310a, 310b, 310c) may then process the EM waves that they respectively receive, using for example an on-board processor, or an FPGA 325 external to the user device. By processing the respectively received EM waves, user devices 310a-310c are able to reconstruct the corresponding holographic information encoded in metasurface 320. Such information may be displayed, for example, on respective displays of user devices 310a-310c.

The word “a” or “an” when used in conjunction with the term “comprising” or “including” in the claims and/or the specification may mean “one”, but it is also consistent with the meaning of “one or more”, “at least one”, and “one or more than one” unless the content clearly dictates otherwise. Similarly, the word “another” may mean at least a second or more unless the content clearly dictates otherwise.

The terms “coupled”, “coupling” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through one or more intermediate elements or devices via a mechanical element depending on the particular context. The term “and/or” herein when used in association with a list of items means any one or more of the items comprising that list.

As used herein, a reference to “about” or “approximately” a number or to being “substantially” equal to a number means being within +/−10% of that number.

While the disclosure has been described in connection with specific embodiments, it is to be understood that the disclosure is not limited to these embodiments, and that alterations, modifications, and variations of these embodiments may be carried out by the skilled person without departing from the scope of the disclosure.

It is furthermore contemplated that any part of any aspect or embodiment discussed in this specification can be implemented or combined with any part of any other aspect or embodiment discussed in this specification.

1. A system for controlling a metasurface having formed thereon subwavelength structures each encoded with holographic information, the system comprising:
one or more transmitters; and
a controller configured to:
control the one or more transmitters to generate one or more radiation patterns, each radiation pattern comprising one or more radio-frequency (RF) beams directed towards the metasurface for interacting with one or more of the subwavelength structures to thereby output, from the metasurface, electromagnetic waves for reconstructing at least some of the holographic information.

2. The system of claim 1, wherein each transmitter of the one or more transmitters comprises an antenna array or a reconfigurable intelligent surface.

3. The system of claim 1, wherein the system is a user device and does not comprise the metasurface.

4. The system of claim 1, further comprising the metasurface.

5. The system of claim 4, wherein the system is a display unit comprising the metasurface.

6. The system of claim 4, wherein the metasurface comprises:
an array of surface tiles, each surface tile having formed thereon one or more of the subwavelength structures.

7. The system of claim 1, further comprising:
a first component configured to:
receive electromagnetic waves output from the metasurface when the one or more RF beams interact with the one or more of the subwavelength structures; and
a second component configured to:
reconstruct the at least some of the holographic information based on the received electromagnetic waves.

8. The system of claim 7, wherein the system is a user device comprising the first component and the second component.

9. The system of claim 1, wherein a size of an aperture of the one or more transmitters is not greater than \sqrt{Sλ/2}, wherein S is a distance between the one or more transmitters and the metasurface, and lambda is a wavelength of the electromagnetic waves.

10. The system of claim 1, wherein:
the subwavelength structures comprise:
a first subwavelength structure formed on a first surface tile of the metasurface and encoded with first holographic information; and
a second subwavelength structure formed on a second surface tile of the metasurface and encoded with second holographic information; and
the controller is further configured to:
control the one or more transmitters to direct the one or more RF beams towards the first and second surface tiles of the metasurface.

11. The system of claim 10, wherein the controller is further configured to:
control the one or more transmitters to direct the one or more RF beams towards the first surface tile of the metasurface; and
subsequently, control the one or more transmitters to direct the one or more RF beams towards the second surface tile of the metasurface.

12. The system of claim 10, wherein the controller is further configured to:
control the one or more transmitters to simultaneously direct the one or more RF beams towards the first and second surface tiles of the metasurface.

13. A method of controlling a metasurface having formed thereon subwavelength structures encoded with holographic information, the method comprising:
controlling one or more transmitters so as to generate one or more radiation patterns each comprising one or more radio-frequency (RF) beams that are directed towards the metasurface, wherein the one or more RF beams interact with one or more of the subwavelength structures so as to output, from the metasurface, electromagnetic waves for reconstructing at least some of the holographic information.

14. The method of claim 13, further comprising:
receiving the electromagnetic waves output from the metasurface; and
reconstructing the at least some of the holographic information based on the received electromagnetic waves.

15. The method of claim 13, wherein:
the one or more subwavelength structures comprise:
a first subwavelength structure formed on a first surface tile of the metasurface and encoded with first holographic information; and
a second subwavelength structure formed on a second surface tile of the metasurface and encoded with second holographic information; and
controlling the one or more transmitters comprises:
controlling the one or more transmitters so as to direct the one or more RF beams towards the first and second surface tiles of the metasurface.

16. The method of claim 14, wherein controlling the one or more transmitters comprises:
controlling the one or more transmitters so as to direct the one or more RF beams towards the first surface tile of the metasurface; and
subsequently, controlling the one or more transmitters so as to direct the one or more RF beams towards the second surface tile of the metasurface.

17. The method of claim 14, wherein controlling the one or more transmitters comprises:
controlling the one or more transmitters so as to direct the one or more RF beams simultaneously towards the first and second surface tiles of the metasurface.

18. The method of claim 13, wherein:
the one or more RF beams comprise a first RF beam and a second RF beam; and
controlling the one or more transmitters comprises:
controlling the one or more transmitters so as to direct the first RF beam towards a first surface tile of the metasurface, the first surface tile having formed thereon a first subwavelength structure of the one or more subwavelength structures and encoded with first holographic information, wherein the first RF beam interacts with the first subwavelength structure so as to generate first electromagnetic waves; and
controlling the one or more transmitters so as to direct the second RF beam towards a second surface tile of the metasurface, the second surface tile having formed thereon a second subwavelength structure of the one or more subwavelength structures and encoded with second holographic information, wherein the second RF beam interacts with the second subwavelength structure so as to generate second electromagnetic waves.

19. The method of claim 13, further comprising, prior to controlling the one or more transmitters:
receiving one or more signals having encoded therein information based on the holographic information, and
wherein controlling the one or more transmitters comprises controlling the one or more transmitters so as to generate one or more radiation patterns based on the information encoded in the one or more signals.

20. The method of claim 19, wherein:
receiving the one or more signals comprises receiving the one or more signals at a user device;
controlling the one or more transmitters comprises controlling the one or more transmitters using the user device; and
the method further comprises:
receiving, at the user device, the electromagnetic waves output from the metasurface; and
reconstructing the at least some of the holographic information based on the received electromagnetic waves.
